(19) United States
(12) Patent Application Publication
(10) Pub. No.: US 2006/0064246 A1
(43) Pub. Date: Mar. 23, 2006

(54) Automated Processing of chemical arrays and systems therefore

(76) Inventors: Scott Lee Medberry, San Carlos, CA (US); Xiangyang Zhou, Mountain View, CA (US); Jayati Ghosh, San Jose, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/946,142

(22) Filed: Sep. 20, 2004

(51) Int. Cl. G06F 19/00

(52) U.S. Cl. 702/19; 702/20

(57) ABSTRACT

Methods, systems and computer readable media for automatically generating information from chemical arrays. A plurality of image files representative pf features contained on a plurality of substrates, respectively, may be automatically and sequentially generated. Automatic and sequential feature extraction of the image files may be carried out, wherein automatic feature extracting of a first of the automatically generated image files is begun immediately after completion of the generation of that image file while a next substrate is being processed for automatic generation of a next image file therefrom. Methods, systems and computer readable media are provided for automatically generating information from chemical arrays, to include identifying an entity selected from the group consisting of data structures, directories, subdirectories and drives into which image files created from reading the chemical arrays are to be stored; polling the entity for the presence of a next new image file not identified in a most recent previous polling of the entity; automatically feature extracting the next new image file; outputting results from the step of automatically feature extracting the next new image file; iterating the step of polling the entity until a next new image is identified or until a predetermined time or predetermined number of polls have been reached; and repeating the steps of automatically feature extracting, outputting results and iterating polling when a next new image file is identified prior to passage. of the predetermined time or completion of the predetermined number of polls with an iteration.

### BACKGROUND OF THE INVENTION

Array assays between surface bound binding agents or probes and target molecules in solution are used to detect the presence of particular biopolymers. The surface-bound probes may be oligonucleotides, peptides, polypeptides, proteins, antibodies or other molecules capable of binding with target molecules in solution. Such binding interactions are the basis for many of the methods and devices used in a variety of different fields, e.g., genomics (in sequencing by hybridization, SNP detection, differential gene expression analysis, comparative genomic hybridization, identification of novel genes, gene mapping, finger printing, etc.) and proteomics.

One typical array assay method involves biopolymeric probes immobilized in an array on a substrate such as a glass substrate or the like. A solution containing analytes that bind with the attached probes is placed in contact with the array substrate, covered with another substrate such as a coverslip or the like to form an assay area and placed in an environmentally controlled chamber such as an incubator or the like. Usually, the targets in the solution bind to the complementary probes on the substrate to form a binding complex. The pattern of binding by target molecules to biopolymer probe features or spots on the substrate produces a pattern on the surface of the substrate and provides desired information about the sample. In most instances, the target molecules are labeled with a detectable tag such as a fluorescent tag or chemiluminescent tag. The resultant binding interaction or complexes of binding pairs are then detected and read or interrogated, for example by optical means, although other methods may also be used. For example, laser light may be used to excite fluorescent tags, generating a signal only in those spots on the biochip (substrate) that have a target molecule and thus a fluorescent tag bound to a probe molecule. This pattern may then be digitally scanned for computer analysis.

As such, optical scanners play an important role in many array based applications. Optical scanners act like a large field fluorescence microscope in which the fluorescent pattern caused by binding of labeled molecules on the array surface is scanned. In this way, a laser induced fluorescence scanner provides for analyzing large numbers of different target molecules of interest, e.g., genes/mutations/alleles, in a biological sample.

Scanning equipment used for the evaluation of arrays typically includes a scanning fluorometer. A number of different types of such devices are commercially available from different sources, such as Perkin-Elmer, Agilent Technologies, Inc., Axon Instruments, and others. In such devices, a laser light source generates a collimated beam. The collimated beam is focused on the array and sequentially illuminates small surface regions of know location on an array substrate. The resulting fluorescence signals from the surface regions are collected either confocally (employing the same lens to focus the laser light onto the array) or off-axis (using a separate lens positioned to one side of the lens used to focus the laser onto the array). The collected signals are then transmitted through appropriate spectral filters, to an optical detector. A recording device, such as a computer memory, records the detected signals and builds up a raster scan file of intensities as a function of position, or time as it relates to the position.

Analysis of the data (the stored file) may involve collection, reconstruction of the image, feature extraction from the image and quantification of the features extracted for use in comparison and interpretation of the data. Where large numbers of array files are to be analyzed, the various arrays from which the files were generated upon scanning may vary from each other with respect to a number of different characteristics, including the types of probes used (e.g., polypeptide or nucleic acid), the number of probes (features) deposited, the size, shape, density and position of the array of probes on the substrate, the geometry of the array, whether or not multiple arrays or subarrays are included on a single slide and thus in a single, stored file resultant from a scan of that slide, etc.

Processing of multiple files to date, has involved a substantial amount of user interaction and time-consuming set up and user input in order to process the files. Past solutions for imaging and data extraction of microarrays has required user intervention at multiple points in the processing, resulting not only in a requirement for the user to be present when such inputs are needed, but also causing time delays until such information needed to be inputted is inputted for a series of microarrays (when batch processing) before continuing the processing, as a batch.

An existing system may be able to image a batch of up to forty-eight microarray images/slide images without user intervention, for example, but analysis of the images does not begin on any of the processed images until a user is present at the system to manually analyze each of the images, one at a time. Each image may take up to eight minutes to image process and an additional fifteen minutes to analyze. Even where automated analysis is possible, such analysis also typically runs as a batch subsequent to batch image generation.

Users typically want their results from image processing and analysis of microarray scans as soon as possible, while at the same time, minimizing mistakes and hand-on time (i.e., requirements for user input or interaction).

There remain continuing needs for improved solutions for efficiently imaging and analyzing scanned array images to reduce user input requirements, thereby reducing the costs of processing and potentially increasing the throughput speed of such analysis. It would also be desirable to provide solutions that speed up the time from the beginning of processing until a time when a user receives end results for one or more scanned images, particularly when such scanned images are being processed in batch mode. Further, reliability of results would be improved by reducing incidence of human input error.

### SUMMARY OF THE INVENTION

Methods, systems and computer readable media for automatically generating information from chemical arrays. A plurality of image files representative of features contained on a plurality of substrates or substrate regions, respectively, may be automatically and sequentially generated. Embodiments of the present invention further automatically and sequentially feature extract the image files, wherein automatic feature extracting of a first of the automatically generated image files is begun immediately after completion of the generation of that image file while a next substrate or substrate region is being processed for automatic generation of a next image file therefrom.

Methods, systems and computer readable media are provided for automatically generating information from chemical arrays, to include identifying an entity selected from the group consisting of data structures, directories, subdirectories and drives into which image files created from reading the chemical arrays are to be stored; polling the entity for the presence of a next new image file not identified in a most recent previous polling of the entity; automatically feature extracting the next new image file; outputting results from said step of automatically feature extracting the next new image file; iterating the step of polling the entity until a next new image is identified or until a predetermined time or predetermined number of polls have been reached; and repeating the steps of automatically feature extracting, outputting results and iterating polling when a next new image file is identified prior to passage of the predetermined time or completion of the predetermined number of polls with an iteration.

Methods, systems and computer readable media for automatically generating information from chemical arrays is provided wherein an image production processor is configured to automatically and sequentially generate a plurality of image files representative of features contained on a plurality of substrates or substrate regions, respectively; and a feature extraction processor is configured to automatically and sequentially feature extract the image files; wherein automatic feature extracting of a first of the automatically generated image files is begun immediately after completion of the generation of that image file.

The present invention also covers forwarding, transmitting and/or receiving results from any of the methods described herein.

These and other advantages and features of the invention will become apparent to those persons skilled in the art upon reading the details of the methods, systems and computer readable media as more fully described below.

### BRIEF DESCRIPTION OF THE DRAWINGS

FIG. 1 illustrates a substrate carrying multiple arrays, such as may be processed according to the present invention.

FIG. 2 is an enlarged, partial schematic view of a portion of the substrate of FIG. 1, showing ideal spots or features.

FIG. 3 is a representation of information that may be included in a design file for a grid template.

FIG. 4 is a simple illustration of a scanned image, in which the image has two arrays or subarrays each having three rows and four columns of features.

FIG. 5 is a flow chart illustrating events that may be carried out in automatic and sequential processing of substrates according to the present invention.

FIG. 6 is a flow chart illustrating another example of events that may be carried out for processing substrates according to the present invention.

FIG. 7 is a flow chart illustrating an example of events that may be carried out for automatic and sequential processing of image files according to the present invention.

FIG. 8 is a flow chart illustrating another example of events that may be carried out for automatic and sequential processing of image files according to the present invention.

FIG. 9 illustrates a typical computer system that may be used to practice an embodiment of the present invention.

### DETAILED DESCRIPTION OF THE INVENTION

Before the present methods, systems and computer readable media are described, it is to be understood that this invention is not limited to particular software, hardware, process steps or substrates described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a microarray” includes a plurality of such microarrays and reference to “the batch” includes reference to one or more batches and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

A “microarray”, “bioarray” or “array”, unless a contrary intention appears, includes any one-, two-or three-dimensional arrangement of addressable regions bearing a particular chemical moiety or moieties associated with that region. A microarray is “addressable” in that it has multiple regions of moieties such that a region at a particular predetermined location on the microarray will detect a particular target or class of targets (although a feature may incidentally detect non-targets of that feature). Array features are typically, but need not be, separated by intervening spaces. In the case of an array, the “target” will be referenced as a moiety in a mobile phase, to be detected by probes, which are bound to the substrate at the various regions. However, either of the “target” or “target probes” may be the one, which is to be evaluated by the other.

Methods to fabricate arrays are described in detail in U.S. Pat. Nos. 6,242,266; 6,232,072; 6,180,351; 6,171,797 and 6,323,043. As already mentioned, these references are incorporated herein by reference. Other drop deposition methods can be used for fabrication, as previously described herein. Also, instead of drop deposition methods, photolithographic array fabrication methods may be used. Interfeature areas need not be present particularly when the arrays are made by photolithographic methods as described in those patents.

Following receipt by a user, an array will typically be exposed to a sample and then read. Reading of an array may be accomplished by illuminating the array and reading the location and intensity of resulting fluorescence at multiple regions on each feature of the array. For example, a scanner may be used for this purpose is the AGILENT MICROARRAY SCANNER manufactured by Agilent Technologies, Palo, Alto, Calif. or other similar scanner. Other suitable apparatus and methods are described in U.S. Pat. Nos. 6,518,556; 6,486,457; 6,406,849; 6,371,370; 6,355,921; 6,320,196; 6,251,685 and 6,222,664. Scanning typically produces a scanned image of the array which may be directly inputted to a feature extraction system for direct processing and/or saved in a computer storage device for subsequent processing. However, arrays may be read by any other methods or apparatus than the foregoing, other reading methods including other optical techniques, such as a CCD, for example. or electrical techniques (where each feature is provided with an electrode to detect bonding at that feature in a manner disclosed in U.S. Pat. Nos. 6,251,685, 6,221,583 and elsewhere).

A “design file” is typically provided by an array manufacturer and is a file that embodies all the information that the array designer from the array manufacturer considered to be pertinent to array interpretation. For example, Agilent Technologies supplies its array users with a design file written in the XML language that describes the geometry as well as the biological content of a particular array.

A “grid template” or “design pattern” is a description of relative placement of features, with annotation, that has not been placed on a specific image. A grid template or design pattern can be generated from parsing a design file and can be saved/stored on a computer storage device. A grid template has basic grid information from the design file that it was generated from, which information may include, for example, the number of rows in the array from which the grid template was generated, the number of columns in the array from which the grid template was generated, column spacings, subgrid row and column numbers, if applicable, spacings between subgrids, number of arrays/hybridizations on a slide, etc. An alternative way of creating a grid template is by using an interactive grid mode provided by the system, which also provides the ability to add further information, for example, such as subgrid relative spacings, rotation and skew information, etc.

A “grid file” contains even more information than a “grid template”, and is individualized to a particular image or group of images. A grid file can be more useful than a grid template in the context of images with feature locations that are not characterized sufficiently by a more general grid template description. A grid file may be automatically generated by placing a grid template on the corresponding image, and/or with manual input/assistance from a user. One main difference between a grid template and a grid file is that the grid file specifies an absolute origin of a main grid and rotation and skew information characterizing the same. The information provided by these additional specifications can be useful for a group of slides that have been similarly printed with at least one characteristic that is out of the ordinary or not normal, for example. In comparison when a grid template is placed or overlaid on a particular microarray image, a placing algorithm of the system finds the origin of the main grid of the image and also its rotation and skew. A grid file may contain subgrid relative positions and their rotations and skews. The grid file may even contain the individual spot centroids and even spot/feature sizes.

A “history” or “project history” file is a file that specifies all the settings used for a project that has been run, e.g., extraction names, images, grid templates protocols, etc. The history file may be automatically saved by the system and is not modifiable. The history file can be employed by a user to easily track the settings of a previous batch run, and to run the same project again, if desired, or to start with the project settings and modify them somewhat through user input.

“Image processing” or a “pre-processing” phase of feature extraction processing refers to processing of an electronic image file representing a slide containing at least one array, which is typically, but not necessarily in TIFF format, wherein processing is carried out to find a grid that fits the features of the array, to find individual spot/feature centroids, spot/feature radii, etc. Image processing may even include processing signals from the located features to determine mean or median signals from each feature and/or its surrounding background region and may further include associated statistical processing. At the end of an image processing step, a user has all the information that needs to be gathered from the image.

“Post processing” or “post processing/data analysis”, sometimes just referred to as “data analysis” refers to processing signals from the located features, obtained from the image processing, to extract more information about each feature. Post processing may include but is not limited to various background level subtraction algorithms, dye normalization processing, finding ratios, and other processes known in the art.

A “protocol” provides feature extraction parameters for algorithms (which may include image processing algorithms and/or post processing algorithms to be performed at a later stage or even by a different application) for carrying out feature extraction and interpretation from an image that the protocol is associated with. Protocols are user definable and may be saved/stored on a computer storage device, thus providing users flexibility in regard to assigning/pre-assigning protocols to specific microarrays and/or to specific types of microarrays. The system may use protocols provided by a manufacturer(s) for extracting arrays prepared according to recommended practices, as well as user-definable and savable protocols to process a single microarray or to process multiple microarrays on a global basis, leading to reduced user error. The system may maintain a plurality of protocols (in a database or other computer storage facility or device) that describe and parameterize different processes that the system may perform. The system also allows users to import and/or export a protocol to or from its database or other designated storage area.

An “extraction” refers to a unit containing information needed to perform feature extraction on a scanned image that includes one or more arrays in the image. An extraction includes an image file and, associated therewith, a grid template or grid file and a protocol.

A “feature extraction project” or “project” refers to a smart container that includes one or more extractions that may be processed automatically, one-by-one, in a batch. An extraction is the unit of work operated on by the batch processor. Each extraction includes the information that the system needs to process the slide (scanned image) associated with that extraction.

When one item is indicated as being “remote” from another, this is referenced that the two items are at least in different buildings, and may be at least one mile, ten miles, or at least one hundred miles apart.

“Communicating” information references transmitting the data representing that information as electrical signals over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer. Where the processor is programmable, suitable programming can be communicated from a remote location to the processor, or previously saved in a computer program product. For example, a magnetic or optical disk may carry the programming, and can be read by a suitable disk reader communicating with each processor at its corresponding station.

Reference to a singular item, includes the possibility that there are plural of the same items present.

“May” means optionally.

Methods recited herein may be carried out in any order of the recited events which is logically possible, as well as the recited order of events. All patents and other references cited in this application, are incorporated into this application by reference except insofar as they may conflict with those of the present application (in which case the present application prevails).

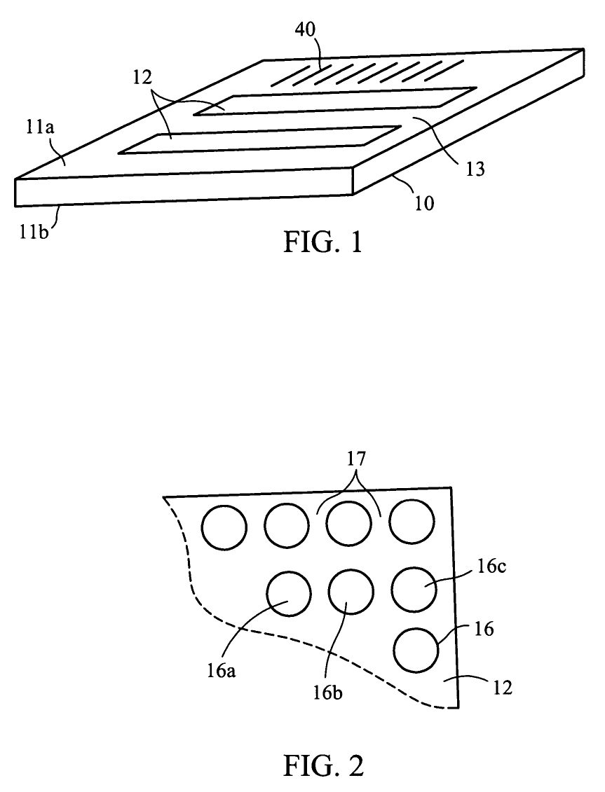

Referring first to FIGS. 1-2, typically methods and systems described herein analyze features that are originally contained on a contiguous planar substrate 10 carrying one or more arrays 12 disposed across a front surface 11a of substrate 10 and separated by inter-array areas 13 when multiple arrays are present. A back side 11b of substrate 10 typically does not carry any arrays 12. The arrays on substrate 10 can be designed for testing against any type of sample, whether a trial sample, reference sample, a combination of them, or a known mixture of polynucleotides (in which latter case the arrays may be composed of features carrying unknown sequences to be evaluated). While two arrays 12 are shown in FIG. 1, it will be understood that substrate 10 may have any number of desired arrays 12.

Arrays on any same substrate 10 may all have the same array layout, or some or all may have different array layouts. Similarly, substrate 10 may be of any shape, and any apparatus used with it adapted accordingly. Depending upon intended use, any or all of arrays 12 may be the same or different from one another and each may contain multiple spots or features 16 of biopolymers in the form of polynucleotides. A typical array. may contain from more than ten, more than one hundred, more than one thousand or more than ten thousand features. All of the features 16 may be different, or some could be the same (for example, when any repeats of each feature composition are excluded the remaining features may account for at least 5%, 10%, or 20% of the total number of features).

Features 16 may be arranged in straight line rows extending left to right, such as shown in the partial view of FIG. 2, for example. In the case where arrays 12 are formed by the conventional in situ or deposition of previously obtained moieties, by depositing for each feature a droplet of reagent in each cycle such as by using a pulse jet such as an inkjet type head, interfeature areas 17 will typically be present which do not carry any polynucleotide or moieties of the array features. It will be appreciated though, that the interfeature areas 17 could be of various sizes and configurations. It will also be appreciated that there need not be any space separating arrays 12 from one another although there typically will be. Each feature carries a predetermined polynucleotide (which includes the possibility of mixtures of polynucleotides). As per usual, A, C, G, T represent the usual nucleotides. It will be understood that there may be a linker molecule (not shown) of any known types between the front surface 11a and the first nucleotide.

An array identifier 40, such as a bar code or other readable format identifier, for both arrays 12 in FIG. 1, is associated with those arrays 12 to which it corresponds, by being provided on the same substrate 10 adjacent one of the arrays 12. A separate identifier can be provided adjacent each corresponding array 12 if desired. Identifier 40 may either contain information on the layout of array 12 or be linkable to a file containing such information in a manner such as described in co-pending, commonly owned application Ser. No. (application Ser. No. not yet assigned, Attorney's Docket No. 10041263-1) filed Sep. 15, 2004 and titled “Automated Feature Extraction Processes and Systems” and further described below, or in U.S. Pat. No. 6,180,351. Application Ser. No. (application Ser. No. not yet assigned, Attorney's Docket No. 10041263-1) and U.S. Pat. No. 6,180,351 are hereby incorporated herein, in their entireties, by reference thereto. Each identifier 40 for different arrays may be unique so that a given identifier will likely only correspond to one array 12 or to arrays 12 on the same substrate 10. This can be accomplished by making identifier 40 sufficiently long and incrementing or otherwise varying it for different arrays 12 or arrays 12 on the same substrate 10, or even by selecting it to be globally unique in a manner in which globally unique identifiers are selected as described in U.S. Pat. No. 6,180,351. However, a portion of identifier 40 may identify a type or group of arrays that have common characteristics and therefore may be at least partially processed in a similar manner, such as with the same grid template and/or the same protocol, etc.

Features 16 can have widths (that is, diameter, for a round feature 16) in the range of at least 10 μm, to no more than 1.0 cm. In embodiments where very small spot sizes or feature sizes are desired, material can be deposited according to the invention in small spots whose width is at least 1.0 μm, to no more than 1.0 mm, usually at least 5.0 μm to no more than 500 μm, and more usually at least 10 μm to no more than 200 μm. The size of features 16 can be adjusted as desired, during array fabrication. Features which are not round may have areas equivalent to the area ranges of round features 16 resulting from the foregoing diameter ranges.

For the purposes of the above description of FIGS. 1-2 and the discussions below, it will be assumed (unless the contrary is indicated) that the array being formed in any case is a polynucleotide array formed by the deposition of previously obtained polynucleotides using pulse jet deposition units. However, it will be understood that the described methods are applicable to arrays of other polymers (such as biopolymers), proteins or chemical moieties generally, whether formed by multiple cycle in situ methods using precursor units for the moieties desired at the features, or deposition of previously obtained moieties, or using other types of dispensers. Thus, in those discussions “polynucleotide”, “polymer” (such as “biopolymer”). “protein” or “chemical moiety”, can generally be interchanged with one another (although where specific chemistry is referenced the corresponding chemistry of an interchanged moiety should be referenced instead). It will also be understood that when methods such as an in situ fabrication method are used, additional steps may be required (such as oxidation and deprotection in which the substrate 10 is completely covered with a continuous volume of reagent).

Following receipt by a user of an array 12, it will typically be exposed to a sample (for example, a fluorescently labeled polynucleotide or protein containing sample) and the array then interpreted to obtain the resulting array signal data. Interpretation requires first reading of the array, which may be initiated by scanning the array, or using some other optical or electrical technique to produce a digitized image of the array which may then be directly inputted to a feature extraction system for direct processing and/or saved in a computer storage device for subsequent processing, as will be described herein.

In order to automatically perform feature extraction, the system requires three components for each extraction performed. One component is the image (scan, or the like, as referred to above) itself, which may be a file saved in an electronic storage device (such as a hard drive, disk or other computer readable medium readable by a computer processor, for example), or may be received directly from an image production apparatus which may include a scanner, CCD, or the like. Typically, the image file is in TIFF format, as this is fairly standard in the industry, although the present invention is not limited to use only with TIFF format images. The second component is a grid template or design file (or, alternatively, a grid file, if the user associates such a file for automatic linking with a particular substrate/image via the substrate's identifier 40) that maps out the locations of the features on the array from which the image was scanned and indicates which genes or other entities that each feature codes for.

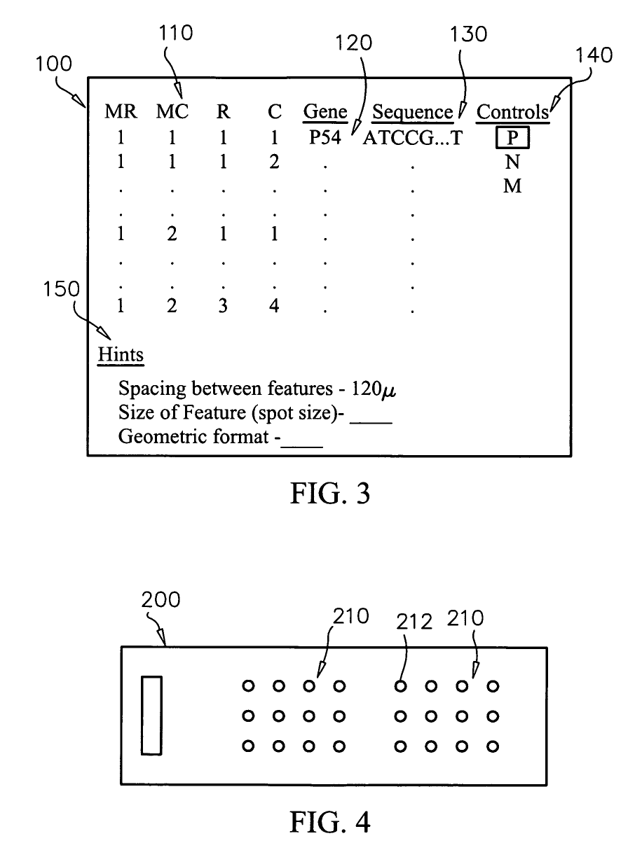

FIG. 3 is a representation of information that may be included in a design file 100 for a grid template. In this example, the feature coordinates 110 are listed for a slide 200 or scanned image thereof having two arrays 210 each having three rows and four columns, see FIG. 4. For each feature on the image, feature coordinates 110 may be provided in grid template. Each feature may be identified by the row and column in which it appears, as well as meta-row and meta-column, that identify which array or subarray that the feature appears in when there are multiple arrays/subarrays on a single slide 200. Thus, for example, the coordinates that read 1 2 1 1 in FIG. 3 refer to feature 212 shown in FIG. 4, that is in row 1, column 1 of the array located in meta-row 1, meta-column 2. Note that there is only one row of arrays (i.e., one meta-row) and two columns of arrays (i.e., two meta-columns).

For each feature, the gene or other entity 120 that that feature codes for may be identified adjacent the feature coordinates. The specific sequence 130 (e.g., oligonucleotide sequence or other sequence) that was laid down on that particular feature may also be identified relative to the mapping information/feature coordinates. Controls 140 used for the particular image may also be identified. In the example shown in FIG. 1, positive controls are used. Typical control indications include, but are not limited to, positive, negative and mismatched. Positive controls result in bright signals by design, while negative controls result in dim signals by design. Mismatched or deletion control provides a control for every probe on the array.

“Hints” 150 may be provided to further characterize an image to be associated with a grid template. Hints may include: interfeature spacing (e.g., center-to-center distance between adjacent features), such as indicated by the value 120 μ in FIG. 3; the size of the features appearing on the image (e.g., spot size); the geometric format of the array or arrays (e.g., rectangular, dense pack, etc.), spacing between arrays/subarrays, etc. The geometric format may be indicated as a hint in the same style that the individual features are mapped in 110. Thus, for example, a hint as to the geometric format of slide 200 may indicate rectangular, 1 2 3 4. Hints assist the system in correctly placing the grid template on the grid formed by the feature placement on a slide/image.

The third component required for automatic feature extraction processing is a protocol. The protocol defines the processes that the system will perform on the image file that it is associated with. Examples of processes that may be identified in the protocol to be carried out on the image file include, but are not limited to: local background subtraction, negative control background subtraction, dye normalization, selection of a specific set of genes to be used as a dye normalization set upon which to perform dye normalization, etc. The system may include a database in which grid templates and protocols may be stored for later call up and association with image files to be processed. The system allows a user to create and manage a list of protocols, as well as a list of grid templates. Protocols are user definable and may be saved to allow users flexibility in pre-assigning protocols to specific images or types of images.

In one embodiment, a feature extraction project may be set up to associate grid templates and/or protocols to image files by default. Thus, for example, a user could start a carousel of slides (for example up to 48 slides may be set up for processing, although the invention is not limited to this number) in the evening for automatic image production and feature extraction, results of which may be obtained the next morning when the user returns.

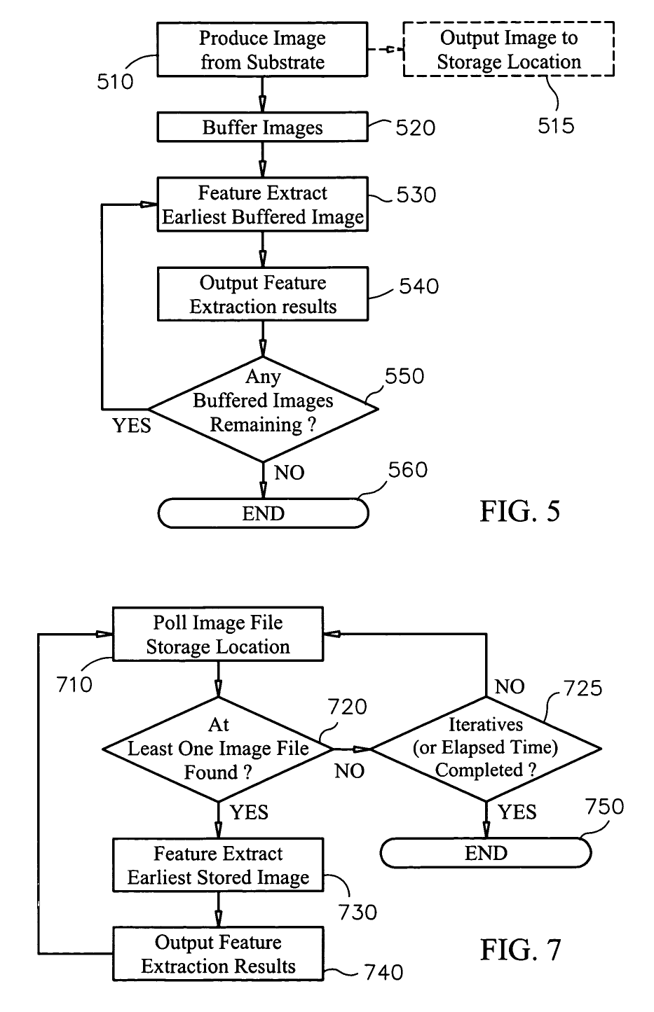

Referring now to FIG. 5, one example of steps that may be carried out in automatic and sequential processing of a plurality of substrates is described. In this case, the system and software for producing images from substrates, such as by scanning, CCD imaging, or the like, is integrated with the system and software for feature extracting the images. At event 510, an image is produced from reading a substrate in any of the manners referred to above, or any equivalent manner that produces a digitized image of the substrate (such as a TIFF image, for example). Note that the apparatus that produces the images from the substrates continues to produce images in an automatic and sequential manner. That is, at event 520, the first produced image is buffered while the apparatus for producing images continues processing to begin production of a second image from reading a second substrate. Image production protocols may be automatically assigned for image production processing of the substrates, based on identifiers 40 associated with the substrates that may be linked to particular protocols, respectively. Optionally, the system may also output images produced at event 510 to a designated storage location 515 that can be accessed by a user to view the image files even before the feature extraction processing of those same files has been produced. Access can be made at any time during the automatic and sequential processing of the substrates, as well as after automatic and sequential processing has been completed.

At event 530, the system receives the earliest buffered image from buffer 530 to begin feature extraction processing of that image. Note that, at the beginning of the process, with the first image, the first image is directly received by the feature extraction process, as it need not be buffered since the feature extraction process has capacity for receiving an image. When feature extraction of an image has been completed, results are outputted at event 540 and the feature extraction process then considers whether there are any buffered images remaining in the buffer. Since feature extraction processing typically, but not always, takes longer than image production, the feature extraction processing may be a limiting step and there should not be concern that there are images left to be produced from substrates when the buffer is empty, since the next image production (assuming a substrate is remaining) should also be completed prior to feature extraction processing of the previous image. However, as noted, this is not always the case, as some scans/image production processes do take longer for production of an image for one substrate compared to the time for feature extracting the image of another substrate. Therefore the system includes a predetermined lag time that the system waits for at event 550 when an image is not immediately identified in the buffer. The predetermined lag time is sufficient to ensure that if a substrate is currently being processed for image production, then that image production processing will finish during the period of the lag time. If there is at least one image remaining in the buffer (including after waiting for the lag time, if necessary), processing returns to event 530. If not, then it is assumed that all substrates have already had images produced therefore and that all images have been feature extracted, and processing ends at event 560.

As the system receives an image for feature extraction processing, it automatically assigns or links a grid template or grid file and a protocol with the image which guide the feature extraction pre-processing and post-processing of the image. There are at least two ways that a grid template can be automatically associated with an image file. The system may provide a database in which available grid templates and protocols may be stored. For example, all of the protocols that are typically used by a given laboratory may be stored in the database for users that work in that laboratory. As already noted above, substrates/slides/arrays often, but not always include a barcode or other identifier (which may be an RF ID, other scan code, or simply a known ordering in the carousel/work holder in which the substrates are placed for processing) 40, which is scanned or otherwise imaged at the same time and along with the production of the image of the array or arrays on the substrate. The barcode or identifier 40 information may be stored in the image file. In this instance, when the image file is received for feature extraction processing, the system reads the associated information from the barcode/identifier 40. This information (or a portion thereof, sometimes referred to as an array ID) may also be linked to a particular grid file that characterizes the image file, and if it does, the system automatically assigns that grid file for use in pre-processing the image for feature extraction. Further, if a user has prior knowledge about a particular substrate, the user may modify a grid template with specific information about that substrate and save it as a grid file, linking it with the identifier 40 for that specific substrate. In this way, a specialized gird file may be automatically assigned to the image produced for that substrate during processing. Grid files are discussed in greater detail in application Ser. No. (application Ser. No. not yet assigned, Attorney's Docket No. 10041263-1).

If an image file received for feature extraction processing does not have a barcode or similar identifier associated with it, then the system cannot read specific information for linking with a particular grid template. In this instance, the system assigns a default grid template for pre-processing this image. A default grid template may be a grid template that is typically used by the laboratory running the project for example. The user has the ability to set a default grid template, as well as a default protocol which will be applied to images during processing of a plurality of images, such as in the example described above (carousel) and the example described with regard to FIG. 5.

Likewise, automatic assignment of a protocol to each image file may be performed based on linking between the grid file already assigned and the protocol. Each grid template that is maintained by the system (such as in a system database, for example) may have a default protocol associated with it. When an image file has an identifier 40 associated with it that the system can use to identify a linked grid template, that grid template is automatically assigned to image file for use in feature extraction processing, as already noted above. Additionally, the system identifies the default protocol that is associated with the grid template that was automatically assigned, and automatically assigns that default protocol for use in feature extraction processing of the image. Alternatively, the protocol assigned may be directly linked to the identifier 40 of the image. For images that do not have an identifier associated therewith, a default protocol is assigned. A default protocol may have been set by the user when setting up the system prior to processing the images, or the system may alternatively rely upon a system default protocol, if no changes were made by the user thereto prior to processing. A global default grid template may also be used by the system when the user has not changed it during setup, prior to processing.

Advantageously, images that are processed by the system may be processed according to different protocols, and they may also have different grid configurations. An important advantage is the automatic and sequential manner in which substrates are processed, so that a user can obtain results of an earlier processed slide before processing of all the slides is completed. Thus, for example, the user may access feature extraction output results of a first slide that the system has completed processing, while the system may be still involved in feature extracting the second image and while the fourth or fifth image may be in the process of being produced. Also, if image production begins in the evening, when a user has left the area, feature extraction can proceed during the night without waiting for user intervention the next morning (or at the start of the next shift).

Each grid template that is stored in a database by the system identifies at least a basic geometry of an image that it will be associated with. That geometry has a certain rigidity or regularity, so that the grid template can be defined to the extent where it can be overlaid on an image to locate the grid defined by the image. However, the actual grid or array that has been deposited on a slide/substrate may be slightly skewed or rotated with respect to the slide, resulting in a similarly skewed or rotated scanned image. The system applies software techniques when overlaying the grid template to match a corner or corners of the image with the grid template, based on hints in the design file for the grid template, and to adjust for skew and/or rotation. Exemplary techniques for this part of the processing are disclosed in co-pending, commonly assigned application Ser. No. 10,449,175 filed May 30, 2003 and titled “Feature Extraction Methods and Systems”. Application Ser. No. 10,449,175 is hereby incorporated by reference in its entirety. Further information regarding grid template modifications and grid fitting techniques may be found in application Ser. No. (application Ser. No. not yet assigned, Attomey's Docket No. 10041263-1).

Not only is the system capable of automatically and sequentially processing image files according to different protocols and/or grid templates, as described above, but the system is also capable of automatically and sequentially processing multipack images with or without single image files interspersed therewith in a plurality of images to be processed. As alluded to above, a substrate may contain more than one array. When a substrate contains more than one array where each array has the same designed of probes, this is referred to as a “multipack” and the image produced therefrom is referred to as a “multipack image”. Typically the arrays on a multipack slide will be hybridized differently, however, so that different results may be achieved on each array, allowing parallel processing of multiple experiments all on the same slide.

The system is adapted to pre-process an entire image as a whole, but post- process on a per-hybridization or per-array basis. Thus, a multipack image is initially processed to grid all of the arrays together for location of features during pre-processing. Once features have been located, divisions between the arrays are determined, and each array is processed individually as to post-processing (e.g., background subtraction, dye normalization, etc.) to determine the results for each array individually.

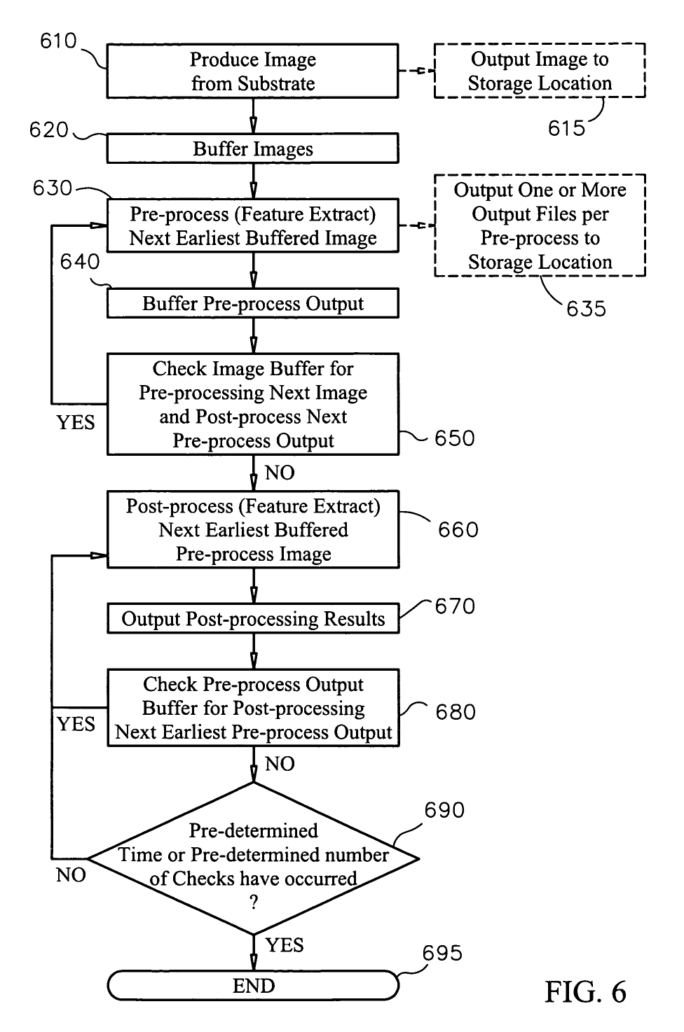

There are distinct advantages to image processing the entire image containing multiple arrays. One advantage is that finding feature location does not have to be repeated multiple times for similar geometries of the multiple arrays contained in the image. Another advantage lies in that, since the geometries of the arrays are similar, there is redundancy provided by the repeating pattern of the array when all are considered together. This may be particularly useful when some features in various arrays are dim or non-existent and would be difficult to locate on the basis of gridding the single array in which the anomalies occur. Even more prominent is the advantage gained in identifying features in an array where no features are readily detectable, by relying on the gridding locations provided by gridding the arrays together. An example of this is schematically shown in FIG. 6 of application Ser. No. (application Ser. No. not yet assigned, Attorney's Docket No. 10041263-1). In such a situation, it is algorithmically more advantageous to find the grid positions of all the individual arrays together rather than one array at a time. Further information regarding algorithmic considerations for locating features can be found in application Ser. No. 10/869,343 filed Jun. 16, 2004 and titled “System and Method of Automated Processing of Multiple Microarray Images” and in application Ser. No. 10,449,175. Application Ser. No. 10/869,343 is hereby incorporated by reference herein, in its entirety, by reference thereto, and application Ser. No. 10,449,175 has already been incorporated by reference above. In the disclosure of application Ser. No. 10/869,343, it is not possible to split the image processing and post processing steps of the analysis, and images are cropped to provide eight single array images from and eight pack multi array image. The present system is capable of imaging the eight pack as a single image, as already noted, therefore the user need only save one image file, as opposed to eight.

After the grid is laid and the system has calculated signal statistics (e.g., mean spot signals for the colors, standard deviations for the spot signals for each color, etc.) for each feature, the system moves to post processing. Post processing is done on a per array basis, rather than a per image basis, since each array typically has a different hybridization and may need a different protocol for data analysis. Also, since the hybridizations are separate the user will typically want separate outputs corresponding to the separate arrays. Post processing may include background subtraction processing, outlier rejection processing, dye normalization, and finding/calculating expression ratios. The protocols for image or post processing are typically XML files that contain the parameters of the algorithms to be used in feature extracting an array image.

Referring now to FIG. 6, another example of steps that may be carried out in automatic and sequential processing of a plurality of substrates is described. In this case, like the previous example, the system and software for producing images from substrates, such as by scanning, CCD imaging, or the like, is integrated with the system and software for feature extracting the images. At event 610, an image is produced from reading a substrate in any of the manners referred to above, or any equivalent manner that produces a digitized image of the substrate (such as a TIFF image, for example). Note that the apparatus that produces the images from the substrates continues to produce images in an automatic and sequential manner. That is, at event 620, the first produced image is buffered (or taken up by feature extraction processing as described below) while the apparatus for producing images continues processing to begin production of a second image from reading a second substrate. Optionally, the system may also output images produced at event 610 to a designated storage location 615 that can be accessed by a user to view the image files even before the feature extraction processing of those same files has been produced. Access can be made at any time during the automatic and sequential processing of the substrates, as well as after automatic and sequential processing has been completed.

At event 630, the system receives the earliest buffered image from buffer 530 to begin feature extraction pre-processing of that image. Note that, at the beginning of the process, with the first image, the first image is directly received by the feature extraction process, as it need not be buffered since the pre-processing feature extraction process has capacity for receiving an image. When feature extraction pre-processing of an image has been completed, a results file (that has been previously formatted as to information that is contained in the results file to be used for post-processing) is placed in a buffer at event 640 (or directly taken up by a process for feature extraction post-processing at event 650 in the case of the first output file produced). Optionally, one or more output files of different formats or focusing on different output data, examples of which are described in application Ser. No. (application Ser. No. not yet assigned, Attorney's Docket No. 10041263-1) may be outputted to a designated storage location at event 635, which may be the same or different from the storage location designated in event 615. Similarly, however, the user may view the pre-processing output results files from the designated storage location at any time after they have been stored there, and need not even wait for completion of post-processing of a particular image file to view the results of pre-processing of the same image file.

At event 650, the system checks the image buffer for accessing the next earliest buffered image, for another iteration of pre-processing at event 630, with optional outputting (event 635) and then buffering the pre-process at event 640. If the image buffer does not contain an image file then the system may wait for a predetermined period (e.g., predetermined lag time) and then re-check before concluding that all image files have been pre-processed. Alternatively, the system may conclude that all image files have been pre-processed without waiting for a predetermined period, and the checking of the image buffer ends and processing proceeds to event 660. In addition to checking at event 650, after buffering pre-processing output at event 640, the system also proceeds to event 660 The system accesses the next pre-process output file (either directly, if it is with regard to the first image file, or the earliest buffered file in the pre-process output buffer) and carries out post-process feature extraction at event 660 with regard to that file. One or more post processing output files per each output post processing event at 660 are outputted at event 670. Output may be to a storage location which may be the same or different as those in events 635, and 615, respectively, and/or to a user interface/display and/or printed out. The number of output files per post-processing event depends upon the formats for output files of post-processing that may be set up by the user prior to beginning processing, or otherwise be determined by default settings of the system. Similarly the storage locations (referred to with regard to events 615, 635 and 670) may be preselected during setup by a user or may be automatically defaulted to under system defaults.

After outputting at event 670, the system check the pre-process output buffer for accessing the next earliest pre-process output in the buffer to post-process that output. If no outputs are found in the pre-process output buffer, the system may recheck the buffer for a predetermined number of times (each separated by a predetermined time interval) or continue checking until a predetermined time interval has passed. If, after one of the foregoing threshold criteria have been met and there are still no outputs in the pre-process output buffer, then the system discontinues checking and concludes that all image files/output files have been post-processed, and ends at event 695. If on the other hand, an output file is identified, then another iteration of events 660, 670 and 690 is carried out to post-process the next earliest pre-process output.

The systems described herein may use a series of calls to subroutines or services that handle each stage of the processing as described. In the examples of FIGS. 5 and 6, image production and feature extraction systems can be combined or integrated to enable integrated, automatic and sequential processing of array containing substrates as noted. During setup, the user may include a plurality of substrates (slides) for automatic processing (such as in a carousel, for example), associate same or different image production and/or feature extraction protocols with each substrate, setup output directories of the images, as well as output files (which may be after all feature extraction processing, or broken down to pre-processing output files and post-processing output files respectively) and run the processing of the substrates in a completely automated and sequential manner.

Another example of a system according to the present invention uses one or more data structures files, subdirectories, drives, or the like to store intermediate and final results of each substrate/image file processed in a series of such substrates/image files. Such an arrangement may include feature extraction apparatus integrated with image production apparatus, similar to those systems described above with regard to FIGS. 5 and 6. However, such a system also lends itself to a separate feature extraction processing system that can be trained on a particular storage location where a separate image production apparatus saves the outputted image files to. Such as system polls or interrogates the data structure(s), files system(s) and/or drive(s) where results are to be stored for new intermediate results to process or for the presence or absence of triggers or locks or other signaling devices or mechanisms that control the processing.

FIG. 7 shows events that may be carried out with a system as described above. Prior to beginning automated processing, a user of a standalone feature extraction system may start the system and direct the system to a location or locations to look for image files and potentially, output files. Of course, the one or more image production systems from which the user wishes to feature extract image files, will also be set to store image files in the same designated area as identified to the feature extraction system. At event 710, the designated storage area for the image files is polled by the feature extraction system. If at least one image file is identified at event 720, then the earliest stored image file is automatically feature extracted according to the techniques that were described above. The feature extraction results (in the form of one or more files as determined by the setup, as also described above) are outputted at event 740, such as to the same storage area that is designated for polling for image files, one or more different designated storage areas, one or more displays, and/or one or more printers. Processing then returns to event 710 to continue polling the designated storage location, wherein any image files having been already feature extraction processed are not considered during the current polling.

If, on the other hand, at least one image file is not found at step 720, then the system may consider at event 725, whether a maximum number of polls for that iteration have already been completed, or whether a preset time interval has already passed for that iteration, without finding at least one image file in the designated storage area that has not already been processed for feature extraction. If the answer to that inquiry at event 725 is yes, then the system ends processing at 750. Alternatively, the system may be set up so that processing does not end until stopped explicitly by a user, or after a set period of time has elapsed. Optionally, event 725 may be foregone, where the system ends processing any time an image file is not found in the designated storage area. This type of setup is applicable where image files already exist in the designated storage area, having been produced prior to the current processing, or even in a real time image production scenario, except that further logic is provided to allow polling until a first image file is detected. After that, any time that the designated storage area does not contain an image file that has not yet been feature extraction processed, then the system may conclude that all images have been processed, since it generally takes much less time to produce an image than to feature extract an image file. However, since this is not always the case, as already noted above, the system may wait for a predetermined lag time period and then re-check the designated storage area for an image file that has not yet been feature extraction processed, and then conclude that all images have been processed if no such image file is found.

If the answer to the inquiry at event 725 is no, that another polling of the designated location is carried out at event 710.

It is noted that multiple processors may carry out the events described with regard to FIG. 7, or one or more multi-threaded processors, or the like, so that more than one feature extraction process may be being carried out at any one time. However, it is noted that the processing is still automatic and sequential, since the order in which the image files are taken up by the one or more processors is sequential, on a first in, first out basis. Further, more than one image production processors or systems may be used to store image files to the designated storage area. Again, however, the image files will be processed on a first, in first out basis, that is, the first image to be stored will be the first image to be feature extraction processed, the second image stored will be the second image file to be feature extraction processed, and so on.

Another variation of the systems described herein, is that the one or more image production processors, modules or systems that may be involved in providing image files for feature extraction processing may be setup, prior to image production to output image files from a designated subset of the substrates to be considered, to another location that will not be considered for feature extraction processing (i.e., either not directed to the buffer or to the designated storage area). Such a setup may be performed by designating specific substrate ID's 40 or a group of similar type of arrays which can also be identified through a portion of the ID. Alternative, specific sequence numbers of the substrates to be inputted to the image production processor(s) may be identified. This type of setup may be desirable when a user wants image files of all the substrates being considered, but has more urgent needs for the feature extraction results for some substrates than for others. The image files in the subset not immediately considered can be stored in a storage area for subsequent feature extraction processing, such as according to the techniques described with regard to FIG. 7, for example.

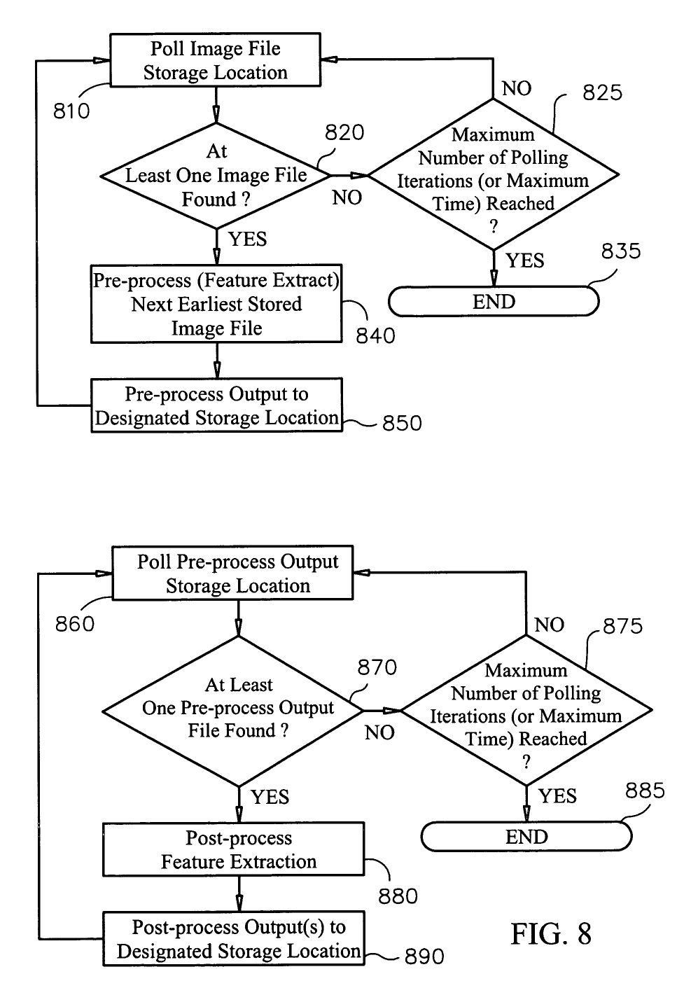

Referring now to FIG. 8, another example of events that may be carried out with a system as described above is shown. Prior to beginning automated processing, a user of a standalone feature extraction system may start the system and direct the system to a location or locations to look for image files and potentially, output files. Of course, the one or more image production systems from which the user wishes to feature extract image files, will also be set to store image files in the same designated area as identified to the feature extraction system. At event 810, the designated storage area for the image files is polled by the feature extraction system. If at least one image file is identified at event 820, then pre-processing feature extraction of the earliest stored image file is automatically carried out at event 840 according to the techniques that were described above. Events 825 and 835 are carried out similarly to events 725 and 750 described above.

The pre-processing feature extraction results are outputted at event 850 to a designated storage location, which may the same as or different from the storage location designated for the image files that is polled at event 810.

During the first execution of event 840 or 850, a trigger may be executed to begin polling for pre-process output files. After event 850 polling is carried out again at event 810 to locate the next image file to be processed.

Polling at 860 is carried out to identify existence of one or more pre-process outputs in the designated storage location. If at least one pre-process output file is found at event 870 in the designated storage area that has not already been post-processed, then post-processing feature extraction is automatically carried out at event 880 on the earliest stored pre-processing output file that has not already been post-processed. One or more post-processing output files (depending on the setup, as noted above) are outputted to a designated storage location which may be the same as, or different from the storage location for the image files and/or pre-processing output files.

Processing then returns to event 860 to continue polling for the next earliest stored pre-process output file.

If, at event 870, at least one pre-process output file is not identified that has not already been post-processed, then iteration of polling continues until a pre-process output file is identified that has not been already post-processed (as determined at event 870) or until a maximum number of polls have been carried out or a maximum time has elapsed as determined at event 875, at which time the processing ends at event 885.

It is noted that, although the process, once setup and initiated is completely automatic and sequential, that a user can access the one or more storage locations that the image files, pre-processing output files and post-processing output files are stored in, thus providing maximum flexibility to the user as to when results can be obtained. Also, since processing is sequential, a user can get complete results from the first substrate processed, often much before all processing completes.

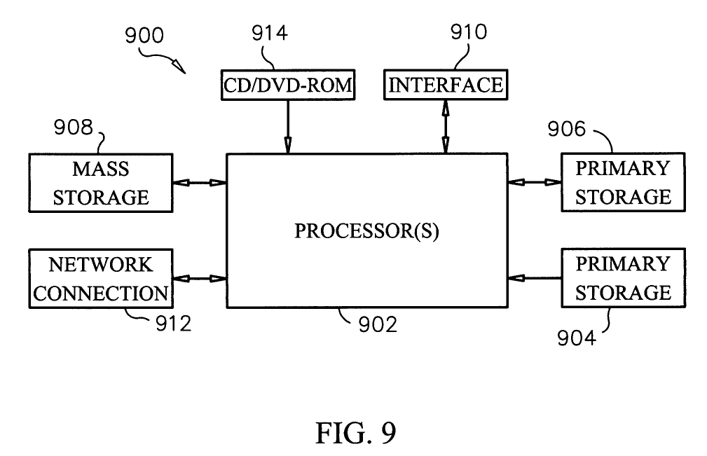

FIG. 9 illustrates a typical computer system that may be used to practice an embodiment of the present invention. The computer system 900 includes any number of processors 902 (also referred to as central processing units, or CPUs) that are coupled to storage devices including primary storage 906 (typically a random access memory, or RAM), primary storage 904 (typically a read only memory, or ROM). As is well known in the art, primary storage 904 acts to transfer data and instructions uni-directionally to the CPU and primary storage 906 is used typically to transfer data and instructions in a bi-directional manner Both of these primary storage devices may include any suitable computer-readable media such as those described above. A mass storage device 908 is also coupled bi-directionally to CPU 902 and provides additional data storage capacity and may include any of the computer-readable media described above. Mass storage device 908 may be used to store programs, data and the like and is typically a secondary storage medium such as a hard disk that is slower than primary storage. It will be appreciated that the information retained within the mass storage device 908, may, in appropriate cases, be incorporated in standard fashion as part of primary storage 906 as virtual memory. A specific mass storage device such as a CD-ROM or DVD-ROM 914 may also pass data uni-directionally to the CPU.

CPU 902 is also coupled to an interface 910 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to a computer or telecommunications network using a network connection as shown generally at 912. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for population of stencils may be stored on mass storage device 908 or 914 and executed on CPU 908 in conjunction with primary memory 906.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A method of automatically generating information from chemical arrays, said method comprising the steps of:
automatically and sequentially generating a plurality of image files representative of features contained on a plurality of substrates or substrate regions, respectively;
automatically and sequentially feature extracting the image files, wherein automatic feature extracting of a first of the automatically generated image files is begun immediately after completion of the generation of that image file while a next substrate or substrate region is being processed for automatic generation of a next image file therefrom.

2. The method of claim 1, wherein said automatically and sequentially feature extracting the image files comprises automatically assigning a grid template and a protocol to each image file, each said image file being feature extracted according to the grid template and protocol assigned thereto.

3. The method of claim 2, comprising automatically assigning at least one of a grid file and a protocol to at least one image file in said plurality of image files that is different from at least one of a grid file and a protocol, respectively automatically assigned to at least one other image file in said plurality of image files.

4. The method of claim 2, wherein at least one of said automatic assignments of a grid template and protocol is made based on an identifier associated with the image to which the assignment is made, said identifier being linked with the assigned grid template and protocol.

5. The method of claim 1, wherein said automatically and sequentially feature extracting the image files comprises automatically and sequentially pre-processing and post-processing the image files, wherein automatic post-processing of a first of the automatically pre-processed image files is begun immediately after completion of the pre-processing of that image file while a next image file is being pre-processed.

6. The method of claim 1, wherein said image files are automatically and sequentially generated by scanning the substrates.

7. The method of claim 1, wherein the features contained on each substrate are contained in one or more arrays on each substrate.

8. The method of claim 7, wherein the arrays are polynucleotide or peptide arrays.

9. The method of claim 1, further comprising designating a selected subset of said plurality of image files generated to be outputted to a storage location where the selected subset of image files will not be automatically and sequentially feature extracted, wherein said step of automatically and sequentially feature extracting the image files is carried out on the remainder of the plurality of image files that do not belong to the selected subset.

10. A method comprising forwarding a result obtained from the method of claim 1 to a remote location.

13. A method comprising transmitting data representing a result obtained from the method of claim 1 to a remote location.

14. A method comprising receiving a result obtained from a method of claim 1 from a remote location.

15. A method of automatically generating information from chemical arrays, said method comprising the steps of:
identifying an entity selected from the group consisting of data structures, directories, subdirectories and drives into which image files created from reading the chemical arrays are to be stored;
polling the entity for the presence of a next new image file not identified in a most recent previous polling of the entity;
automatically feature extracting the next new image file;
outputting results from said step of automatically feature extracting the next new image file;
iterating said step of polling the entity until a next new image is identified or until a predetermined time or predetermined number of polls have been reached; and
repeating said steps of automatically feature extracting, outputting results and iterating polling when a next new image file is identified prior to passage of the predetermined time or completion of the predetermine number of polls with an iteration.

16. The method of claim 15, wherein the step of automatically feature extracting the next new image file comprises:
automatically pre-processing the next new image file;
outputting results of said pre-processing to an output entity selected from the group consisting of data structures, directories, subdirectories and drives, wherein said output entity may be the same as or different from said entity;
polling the output entity for the presence of a next new pre-processing results output not identified in a most recent previous polling of the entity; and
automatically post-processing the next new pre-processing results while automatic pre-processing of the next new image file is being carried out.

17. The method of claim 16, further comprising outputting post-processing results to a post-processing entity which is the same as or different from said entity and is the same as or different from said output entity;
polling the output entity for the presence of a next new pre-processing results output not identified in a most recent previous polling of the entity; and
automatically post-processing the next new pre-processing results.

18. The method of claim 15, wherein said automatic feature extraction includes automatically assigning a grid template and a protocol to each image file, each said image file being feature extracted according to the grid template and protocol assigned thereto.

19. The method of claim 18, comprising automatically assigning at least one of a grid file and a protocol to at least one of the image files that is different from at least one of a grid file and a protocol, respectively automatically assigned to at least one other of the image files.

20. The method of claim 18, wherein at least one of said automatic assignments of a grid template and protocol is made based on an identifier associated with the image to which the assignment is made, said identifier being linked with the assigned grid template and protocol.

21. The method of claim 15, wherein at least one of said image files contains multiple arrays.

22. A system for automatically generating information from chemical arrays, said system comprising:
an image production processor configured to automatically and sequentially generate a plurality of image files representative of features contained on a plurality of substrates or substrate regions, respectively; and
a feature extraction processor configured to automatically and sequentially feature extract the image files; wherein automatic feature extracting of a first of the automatically generated image files is begun immediately after completion of the generation of that image file.

23. The system of claim 22, wherein said image production processor and said feature extraction processor are embodied by a single processor, and wherein image production of a next substrate or substrate region is automatically carried out after completion of feature extraction processing of a previous image, wherein said image production and feature extraction are carried out in the order stated, alternating automatically and sequentially.

24. The system of claim 22, wherein said image production processor processes a next substrate or substrate region for automatic generation of a next image file therefrom while said feature extraction processor processes the previous image.

25. The system of claim 22, comprising a plurality of image production processors, wherein said image production processors cooperate to automatically and sequentially generate the plurality of image files.

26. The system of claim 22, comprising a plurality of feature extraction processors, wherein said feature extraction processors cooperate to automatically and sequentially process the plurality of image files for feature extraction.

27. The system of claim 22, further comprising a storage entity into which the image files are stored upon production thereof, wherein said feature extraction processor automatically and sequentially accesses the image files in said storage entity to feature extract the image files.

28. The system of claim 22, comprising a plurality of image production processors, wherein said image production processors cooperate to automatically and sequentially generate the plurality of image files;
a storage entity into which the image files are stored upon production thereof by said image production processors; and
a plurality of feature extraction processors, wherein said feature extraction processors cooperate to automatically and sequentially process the plurality of image files for feature extraction, and wherein said feature extraction processors automatically and sequentially accesses the image files in said storage entity to feature extract the image files.

29. A computer readable medium carrying one or more sequences of instructions for automatically generating information from chemical arrays, wherein execution of one or more sequences of instructions by one or more processors causes the one or more processors to perform the steps of:
automatically and sequentially generating a plurality of image files representative of features contained on a plurality of substrates or substrate regions, respectively;
automatically and sequentially feature extracting the image files, wherein automatic feature extracting of a first of the automatically generated image files is begun immediately after completion of the generation of that image file while a next substrate or substrate region is being processed for automatic generation of a next image file therefrom.
